(19) United States
(12) Patent Application Publication
(10) Pub. No.: US 2014/0324742 A1
(43) Pub. Date: Oct. 30, 2014

(54) SUPPORT VECTOR MACHINE

(71) Applicant: HEWLETT-PACKARD DEVELOPMENT COMPANY, L.P., (US)

(72) Inventor: Kave Eshghi, Los Altos, CA (US)

(73) Assignee: HEWLETT-PACKARD DEVELOPMENT COMPANY, L.P., Houston, TX (US)

(21) Appl. No.: 13/873,587

(22) Filed: Apr. 30, 2013

(51) Int. Cl. G06N 99/00

(52) U.S. Cl. CPC G06N 99/005
USPC 706/12

(57) ABSTRACT

A method of building a classification model using a SVM training module comprising, with a processor, computing a mean value of a number of training vectors received by the processor, subtracting the mean value of the number of training vectors from each training vector received by the processor to obtain a number of difference vectors, applying a hash function to each of the difference vectors to obtain a number of hashed vectors, and applying a linear training formula to the hashed vectors to obtain a classifier model. Classifying a sample vector comprises, with a processor, subtracting a mean value of a number of support vector machine training vectors from the sample vector to obtain a sample difference vector, with a processor, applying a hash function to the sample difference vector to obtain a hashed sample vector, and classifying the hashed sample vector using a classifier model.

### BACKGROUND

Support vector machines (SVMs) are learning routines used for classification of input data received by a computing system. The input data objects may be represented by a set of one or more feature vectors, where a feature vector can include aspects of the data object that is being represented. For example an image file can be associated with a relatively large number of feature vectors, where each feature vector of the image file represents some different aspect of the image file. The SVMs may first be trained with a number of feature vectors in order to proceed to classify other input data vectors.

### BRIEF DESCRIPTION OF THE DRAWINGS

The accompanying drawings illustrate various examples of the principles described herein and are a part of the specification. The examples do not limit the scope of the claims.

FIG. 1 is a block diagram of a system for training and classifying data according to one example of principles described herein.

FIG. 2 is a flowchart showing a method of building a classification model using a SVM training module of FIG. 1 according to one example of principles described herein.

FIG. 3 is a flowchart showing a method of classifying a sample vector received by the processor according to one example of principles described herein.

Throughout the drawings, identical reference numbers designate similar, but not necessarily identical, elements.

### DETAILED DESCRIPTION

SVMs may be used to classify both linear and non-linear data sets. Linear SVMs with high dimensional sparse vectors as the input data are extremely efficient for both training and classification. However, linear SVMs are useful for only some particular types of data. Indeed, implementing a linear SVM may be disadvantageous when the input data is not easily separable by a single line, meaning that the data points on a two dimensional graph cannot be separated by a single straight line. In this case, a non-linear SVM may be used to classify data points received by the computing device. However, non-linear SVMs also have drawbacks. In using a non-linear SVM to classify input data, it may be that both the training and classification formulas are resource intensive in that it requires a high amount of memory and processing power to complete the classification.

Non-linear SVM implementing a Gaussian radial basis function (RBF) kernel has also been used as a machine learning technique. It has been shown in a number of experiments that for many types of data, its classification accuracy far surpasses linear SVM. For example, for the MNIST handwritten number recognition dataset, a non-linear SVM may achieve accuracy of 98.6%, whereas a linear SVM may only achieve an accuracy of 92.7%. As discussed above, the drawback of a non-linear SVM is that both training and classification can be very expensive. Typically, training takes O(n²) operations, where n is the number of training instances. Classification may also be expensive because, for each classification task, a kernel function is applied for each of the support vectors. As it may be appreciated, this number may be relatively large. Consequently, non-linear SVMs are less often used when the number of training instances and support vectors is large.

With a Gaussian kernel, the feature space is infinite dimensional. As a result, some training and classification solutions use the ‘kernel trick’, where all computations are done using the dot product of feature vectors. These dot products are computed implicitly using the kernel function. The exact solutions use the full n×n kernel matrix, while approximate solutions use a low rank approximation of the kernel matrix. When n is large and the number of support vectors is also large, the kernel matrix takes a relatively longer time to compute and the result may be so large as to not fit in the memory of the computing device. Additionally, training and classification time may be dominated by the cost of computing the kernel function. For example Libsvm, which is a state of the art implementation, takes order of hours to train when using, for example, the MNIST hand-written digit classification.

In order to speed up both the training and classification processes, a method of circumventing the drawbacks of both non-linear and linear SVMs may be implemented. Therefore, the present specification describes a mapping, using concomitant rank order hash functions, that transforms a non-linear SVM on dense data to a high-dimensional, sparse linear SVM. The result is a relatively faster training and classification of input data, with all the same accuracy as a non-linear SVM. In this case, a number of relatively efficient linear SVM training and classification formulas can be used in the feature space, while preserving the relatively high accuracy of the original Gaussian RBF kernel. In one experimental example using the MNIST hand-written digit data set (60,000 example data sets) the SVM can be trained in less than one minute, where using a standard non-linear SVM may take hours. The classification accuracy, however, remained the same. Classification was also orders of magnitude faster with the approach described herein.

In the present specification and in the appended claims the term “input data” may refer to any data received by a processor executing a support vector machine. In one example, the support vector machine may receive input data in the form of a vector that has been extracted from an input data object. A feature vector may be extracted from any input data object where the feature vector is representative of some aspect of the input data object. In some implementations, an input data object can be associated with one feature vector. In other implementations, an input data object can be associated with a number of feature vectors. A feature vector (or more simply, a “vector”) can be made up of a collection of elements, such as a sequence of real numbers.

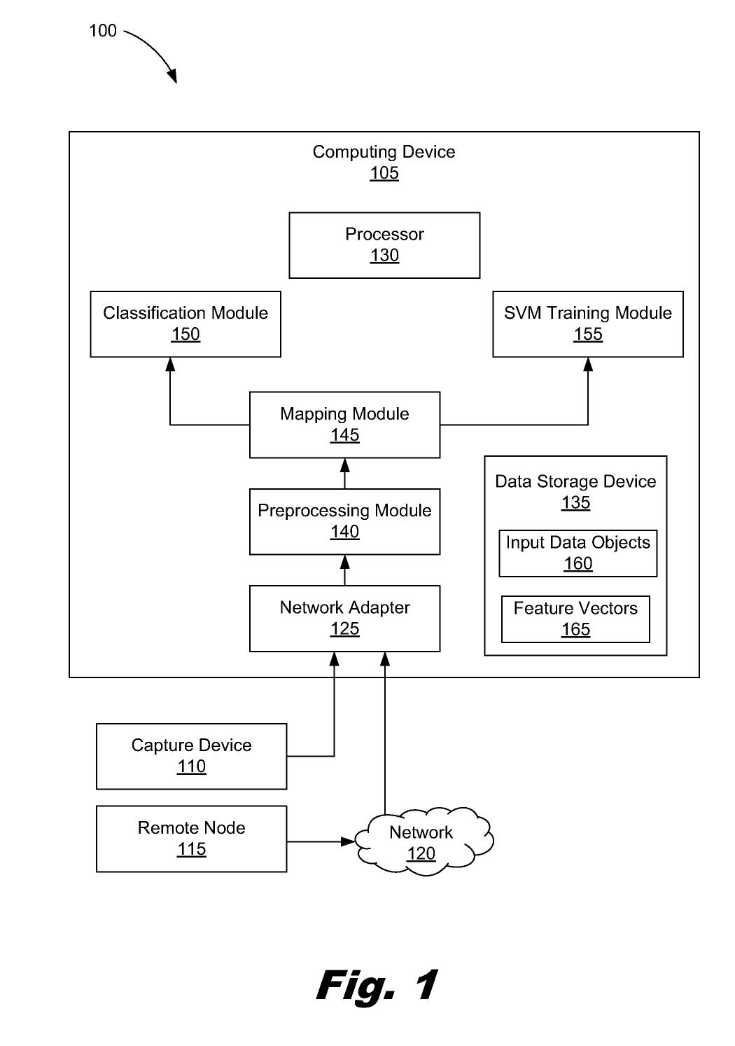

FIG. 1 is a block diagram of a system (100) for training and classifying data according to one example of principles described herein. The system (100) may comprise a computing device (105), a capture device (110) and a remote node (115). The capture device may be used by a user of the system to supply a number of input data objects to the computing device (105) in the form of, for example, digital pictures. Therefore, the capture device (110) may be a scanner or camera device. Although, a capture device (110) in FIG. 1 has been described as a device to provide to the computer (105) with a number of input data objects being in the form of a digital picture, the input data objects may be any type of data. In other examples, the remote node (115) may further provide those other types of input data objects, such as text documents, audio files, among others. The remote node (115) may be a computing device capable of transferring such input data objects to the computing device (105) via, for example, a network (120).

The computing device (105) may comprise a network adapter (125) to communicate with either the capture device (110) or the remote node (115). The computing device (105), capture device (110), and remote node (115) may form any type of computer network and may be wired or wirelessly communicatively coupled.

The computing device (105) may comprise a number of hardware devices to execute the method described herein. Specifically, the computing device (105) may comprise a processor (130) and a data storage device (135). As will be described below, the processor (130) may be used by a number of modules associated with the computing device (105) which are used to complete a non-linear support vector machine (SVM) training and classification process. These modules include a preprocessing module (140), a mapping module (145), a classification module (150), and a SVM training module (155). The function of each of these will be discussed in more detail below. Although the modules (140, 145, 150, 155) shown in FIG. 1 are depicted s being included in a single computing device (105), the present specification contemplates that any number of computing devices (105) may be used to execute any number of the modules (140, 145, 150, 155).

The data storage device (135) may include various types of memory devices, including volatile and nonvolatile memory. For example, the data storage device (135) of the present example may include Random Access Memory (RAM), Read Only Memory (ROM), and Hard Disk Drive (HDD) memory, among others. The present specification contemplates the use of many varying type(s) of memory in the data storage device (135) as may suit a particular application of the principles described herein. In certain examples, different types of memory in the data storage device (135) may be used for different data storage needs. In certain examples, the processor (130) may boot from the Read Only Memory (ROM), maintain nonvolatile storage in the Hard Disk Drive (HDD) memory, and execute program code stored in Random Access Memory (RAM).

Generally, the data storage device (135) may comprise a computer readable storage medium. For example, the data storage device (135) may be, but not limited to, an electronic, magnetic, optical, electromagnetic, infrared, or semiconductor system, apparatus, or device, or any suitable combination of the foregoing. More specific examples of the computer readable storage medium may include, for example, the following: a portable computer diskette, a hard disk, a random access memory (RAM), a read-only memory (ROM), an erasable programmable read-only memory (EPROM), flash memory, byte-addressable non-volatile memory (phase change memory, memristors), a portable compact disc read-only memory (CD-ROM), an optical storage device, a magnetic storage device, or any suitable combination of the foregoing, among others. In the context of this document, a computer readable storage medium may be any tangible medium that can contain, or store a program for use by or in connection with an instruction execution system, apparatus, or device.

The data storage device (135) may specifically store the input data objects (160) once received by the network adapter (125). Additionally, the data storage device (135) may store a number of feature vectors (165) extracted from the input data objects (160) as will now be described.

During operation, the computing device (105) receives data objects from either the capture device (110) or remote node (115) at the network adapter (125). The network adapter (135) may send the data objects to the preprocessing module (140) briefly mentioned above. The preprocessing module (140) may receive the input data objects and extract a number of feature vectors from those input data objects. When, for example, a text document is received as the input data object, it may be associated with a single feature vector that can be made up of a collection of words. In another example, where an image file, such as a photograph, is received as the input data object, that photograph is associated with a relatively large number of feature vectors. Other types of data objects that can be associated with feature vectors include audio files, video files, directories, software executable files, and so forth and may be associated with any number of feature vectors.

The preprocessing module (140) provides the feature vectors to the mapping module (145). The mapping module (140) uses a concomitant rank order (CRO) hash function to map k dimensional real vectors to sparse U dimensional vectors, where U is relatively large (for example 2¹⁷). In the present specification and in the appended claims, the term “sparse” is meant to be understood as a relatively small number of the elements of the hash vector that are 1. In this case, a relatively large number of the elements of hash vectors are zero. The application of the hash function, in this example a concomitant rank order (CRO) hash function, to the number of feature vectors is described in U.S. Patent App. Pub. No. 2010/0077015, entitled “Generating a Hash Value from a Vector Representing a Data Object,” to Kaye Eshghi and Snyam Sundar Rajaram, which is hereby incorporated by reference in its entirety.

If, for examples, z₁ and z₂ are two k dimensional vectors, and h₁ and h₂ are their hash vectors, i.e. CRO(z₁)=h₁ and CRO(z₂)=h₂ the following property results:

h₁.h₂=b exp(a cos(z₁,z₂)) (Eq. 1)

for some positive constants a and b. In other words, the inner product of the hash vectors is proportional to the exponential of the cosine of the input vectors. In contrast, with the Gaussian kernel, the exponent is the Euclidian distance between the two input vectors. Here the exponent is the cosine. Thus, where the cosine is a suitable distance measure, a linear SVM can be applied to the hash vectors. As a result, the benefits of a Gaussian kernel are realized without any kernel computations being made.

The mapping module (130) may make the cosine measure an effective distance measure by normalizing the feature vectors by first computing the population mean of the feature vectors and then subtracting the population mean from all the features vectors before applying the above hash function. Subtracting the population mean from all the features vectors results in a number of difference vectors. During the training process described above, the mapping module (130) may apply the hash function using a number of training vectors preprocessed by the preprocessing module (140) using training input data objects. Application of the hash function to the training vectors results in a number of hashed vectors.

The computing device (105) may then use the SVM training module (155) to apply a linear training formula to the hashed vectors. Application of the linear training formula to the hashed vectors results in a classifier model.

After training the SVM training module (155) using a number of input data objects, the computing device (105) may receive any number of sample data objects from the remote node (115) or capture device (110). These sample data objects may be used by the computing device (105) to test the effectiveness of the classifier model or alternatively may be input data objects which are to be classified by the classification module (150). The sample data objects may similarly be preprocessed by the preprocessing module (140) and a number of sample difference vectors may be produced. In this case the mean value of the number of training vectors calculated above is subtracted from the sample difference vector.

The previously mentioned hash function may then be applied to the sample difference vector to obtain a hashed sample vector. Once the hashed sample vector has been calculated using the mapping module (145), the classification module (150) may classify the hashed sample vector using the classifier model described above.

The above system (100), therefore, provides for the efficient training and classification of input data objects while providing results that are relatively as accurate and precise as a non-linear SVM implementing a Gaussian kernel. Additionally, the above system provides for relatively faster training and classification of input data objects than would, for example, a Gaussian kernel.

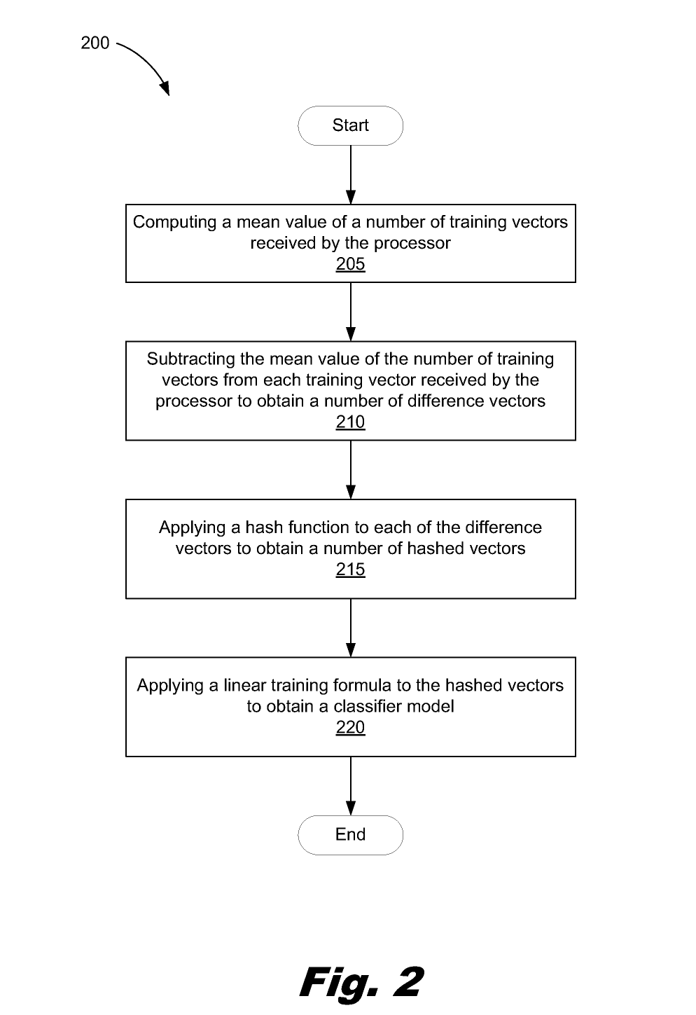

Turning now to FIG. 2, a flowchart describing a method (200) of building a classification model using the SVM training module of FIG. 1 is shown according to one example of principles described herein. The method may begin with the preprocessing module (FIG. 1, 140) computing (205) a mean value of a number of training vectors using the processor (FIG. 1, 130). This may be done by adding a number of training vectors together and then dividing the resulting vector by the number of training vectors used during the building of the classification model. As previously discussed, the training vectors may be acquired by extracting the vectors from a number of input data objects sent from the capture device (FIG. 1, 110) or remote node (FIG. 1, 115).

The resulting mean value of the number of training vectors may then be subtracted (210) from each training vector received by the preprocessing module (FIG. 1, 140). A number of difference vectors are obtained as a result of this subtraction (210).

A hash function may then be applied (215) to each of the difference vectors to obtain a number of hashed vectors. In one example, the hash function is a concomitant rank order (CRO) hash function as described above. The concomitant rank order (CRO) hash function maps k dimensional real vectors to sparse U dimensional vectors.

The hash vectors the have a linear training routine applied (220) to them to obtain a classifier model. The linear training routine may be a linear SVM that takes the hash vectors and creates a classifier model relatively faster and with less resources than if the vectors had been computed using a non-linear support vector machine. One example of a linear training routine is Liblinear.

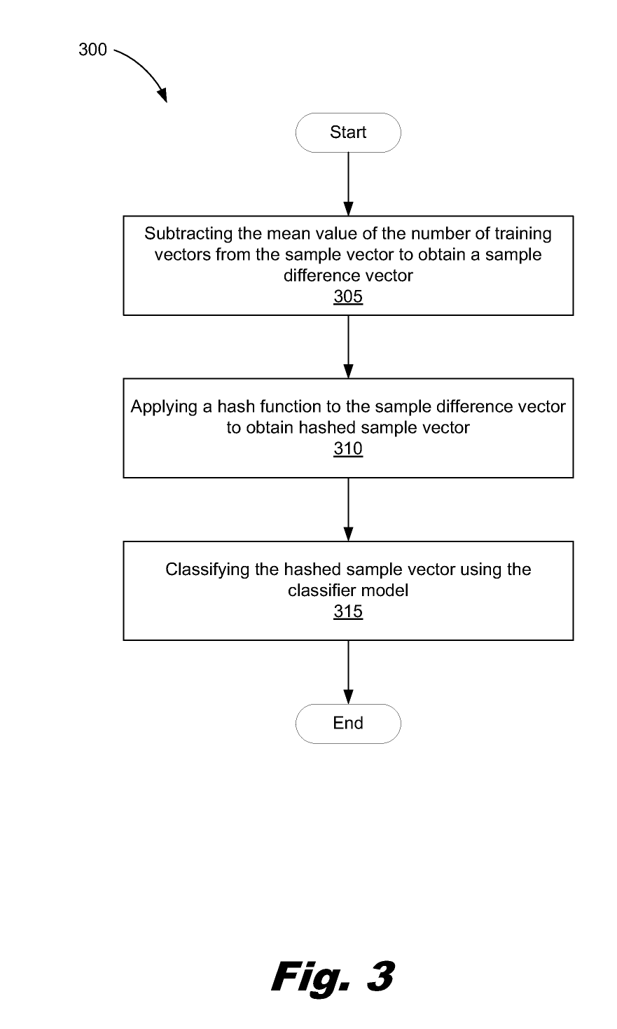

Turning now to FIG. 3, a flowchart describing a method (300) of classifying a sample vector received by the processor (FIG. 1, 130) is shown according to one example of principles described herein. The method (300) may begin with subtracting (305) the mean value of the number of training vectors from the sample vector to obtain a sample difference vector. As described above, the mean value was obtained by adding a number of training vectors together and dividing the resulting vector by the number of training vectors used during the building of the classification model.

The method (300) may continue by applying (310) the hash function to the sample difference vector to obtain a hashed sample vector. In one example, the hash function is a concomitant rank order (CRO) hash function as described above. The concomitant rank order (CRO) hash function maps k dimensional real vectors to sparse U dimensional vectors.

The hashed sample vector may then be classified (315) using the classifier model obtained during the building of classification model described in connection with FIG. 2.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (130) of the computing device (105) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The present specification therefore contemplates a computer program product for building a classification model using the SVM training module and classifying a sample vector. The computer program product may comprise a computer readable storage medium comprising computer usable program code embodied therewith. The computer usable program code may comprise computer usable program code to, when executed by a processor (FIG. 1, 130), computes (FIG. 2, 205) a mean value of a number of training vectors. The computer usable program code may further comprise computer usable program code to, when executed by a processor (FIG. 1, 130), subtracting the mean value of the number of training vectors from each training vector received by the processor to obtain a number of difference vectors. The computer usable program code may also comprise computer usable program code to, when executed by a processor (FIG. 1, 130), apply (FIG. 2, 215) a hash function to each of the difference vectors to obtain a number of hashed vectors. Still further, the computer usable program code may also comprise computer usable program code to, when executed by a processor (FIG. 1, 130), apply (FIG. 2, 220) a linear training formula to the hashed vectors to obtain a classifier model.

The computer usable program code may comprise computer usable program code to, when executed by a processor (FIG. 1, 130), subtract (FIG. 3, 305) the mean value of the number of training vectors from the sample vector to obtain a sample difference vector. Additionally, the computer usable program code may comprise computer usable program code to, when executed by a processor (FIG. 1, 130), apply (FIG. 3, 310) the hash function to the sample difference vector to obtain a hashed sample vector. Further, the computer usable program code may comprise computer usable program code to, when executed by a processor (FIG. 1, 130), classify (FIG. 3, 310) a hashed sample vector using the classifier model obtained during the building of classification model described in connection with FIG. 2.

The specification and figures describe a system and method to build a classification mode and classify a sample vector. By mapping the input vectors to high dimensional, sparse feature vectors, an efficient linear SVM training and classification formula can be used in the feature space. This may be done while preserving the high accuracy realized by, for example, a Gaussian RBF kernel.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of building a classification model using a SVM training module comprising:
with a processor:
computing a mean value of a number of training vectors received by the processor;
subtracting the mean value of the number of training vectors from each training vector received by the processor to obtain a number of difference vectors;
applying a hash function to each of the difference vectors to obtain a number of hashed vectors; and
applying a linear training formula to the hashed vectors to obtain a classifier model.

2. The method of claim 1, further comprising classifying a sample vector received by the processor by:
subtracting the mean value of the number of training vectors from the sample vector to obtain a sample difference vector;
applying the hash function to the sample difference vector to obtain a hashed sample vector; and
classifying the hashed sample vector using the classifier model.

3. The method of claim 1, in which the hash function is a concomitant rank order (CRO) hash function.

4. The method of claim 1, in which the linear training formula is Liblinear.

5. The method of claim 1, in which computing a mean value of a number of training vectors comprises adding a number of training vectors together and then dividing a resulting vector by the number of training vectors.

6. A computer program product for building a classification model, the computer program product comprising:
a computer readable storage medium comprising computer usable program code embodied therewith, the computer usable program code comprising:
computer usable program code to, when executed by a processor, compute a mean value of a number of training vectors received by the processor;
computer usable program code to, when executed by a processor, subtract the mean value of the number of training vectors from each training vector received by the processor to obtain a number of difference vectors;
computer usable program code to, when executed by a processor, apply a hash function to each of the difference vectors to obtain a number of hashed vector; and
computer usable program code to, when executed by a processor, apply a linear training formula to the hashed vectors to obtain a classifier model.

7. The computer program product of claim 6, further comprising:
computer usable program code to, when executed by a processor, subtract the mean value of the number of training vectors from the sample vector to obtain a sample difference vector;
computer usable program code to, when executed by a processor, apply the hash function to the sample difference vector to obtain a hashed sample vector; and
computer usable program code to, when executed by a processor, classify the hashed sample vector using the classifier model.

8. The computer program product of claim 6, in which the hash function is a concomitant rank order (CRO) hash function.

9. The computer program product of claim 6, in which the linear training formula is Liblinear.

10. The computer program product of claim 6, in which the computer usable program code to compute a mean value of a number of training vectors comprises computer usable program code to, when executed by a processor, add a number of training vectors together and then dividing a resulting vector by the number of training vectors.

11. A method of classifying a sample vector extracted from input data using a support vector machine, comprising:
with a processor, subtracting a mean value of a number of support vector machine training vectors from the sample vector to obtain a sample difference vector;
with a processor, applying a hash function to the sample difference vector to obtain a hashed sample vector; and
classifying the hashed sample vector using a classifier model.

12. The method of claim 11, in which the mean value of a number of support vector machine training vectors is obtained previous to classifying the sample vector by adding the number of support vector machine training vectors together and dividing the resulting vector by the number of training vectors.

13. The method of claim 11, in which the hash function is a concomitant rank order (CRO) hash function.

14. The method of claim 13, in which the concomitant rank order (CRO) hash function maps k dimensional real vectors to sparse U dimensional vectors.

15. The method of claim 11, in which the input data is a digital picture.
